(19) United States
(12) Patent Application Publication
(10) Pub. No.: US 2009/0133055 A1
(43) Pub. Date: May 21, 2009

(54) CABLE TELEVISION MESSAGING ALERT SYSTEM

(76) Inventor: Howard Lock, Peshtigo, WI (US)

Correspondence Address: FOLEY & LARDNER LLP, 150 EAST GILMAN STREET, P.O. BOX 1497, MADISON, WI, 53701-1497, US

(21) Appl. No.: 11/942,268

(22) Filed: Nov. 19, 2007

(51) Int. Cl. H04N 7/025; H04N 7/10

(52) U.S. Cl. 725/33

(57) ABSTRACT

An alert message unit for use in a message distribution system is provided. The alert message unit includes an input configured to receive a cable television signal, a processing module in communication with the input, and an alert mechanism. The processing module is configured to locate an alert message, wherein the alert message is embedded within a frequency band of the cable television signal. The processing module is further configured to determine whether the located alert message is addressed to the alert message unit, and activate the alert mechanism if the alert message is addressed to the alert message unit.

### FIELD

The subject of the disclosure relates generally to an alert messaging system for use in conjunction with a cable television system. More specifically, the disclosure relates to a multifunction alert message unit with cable signal detection and a plurality of alert mechanisms.

### BACKGROUND

In a typical television-based alert messaging system, a message is displayed on one or more television channels to warn individuals of an existing or potential emergency situation. The emergency situation can be a weather alert, a breaking news alert, a national security alert, a sports alert, etc. The message can be in the form of scrolling text, video, and/or audio. Unfortunately, current alert messaging systems require the television to be turned on and an individual to be within the vicinity of the television. As such, current systems are limited in their ability to effectively warn individuals who are not watching television when the alert message is issued.

As an example, if the television is in the downstairs of a house and the individual is upstairs, the individual will not be able to see or hear an alert which issues through the television. Similarly, if the individual is working in the yard, reading in the den, working in the garage, or otherwise separated from his/her television, the individual will fail to receive potentially life saving emergency alerts. Thus, there is a need for an alert messaging system which is able to warn an individual regardless of the individual's proximity to a television.

### SUMMARY

An exemplary alert message unit for use in a message distribution system is provided. The alert message unit includes an input configured to receive a cable television signal, a processing module in communication with the input, and an alert mechanism. The processing module is configured to locate an alert message, wherein the alert message is embedded within a frequency band of the cable television signal. The processing module is further configured to determine whether the located alert message is addressed to the alert message unit, and activate the alert mechanism if the alert message is addressed to the alert message unit.

An exemplary system for distributing messages is also provided. The system includes a head end system and an alert message unit in communication with the head end system. The head end system is configured to embed an alert message within a cable television signal to create a modified cable television signal, and send the modified cable television signal to the alert message unit. The alert message unit includes an input configured to receive the modified cable television signal and a processing module in communication with the input. The processing module is configured to locate the alert message within the modified cable television signal, determine whether the located alert message is addressed to the alert message unit, and activate an alert mechanism if the located alert message is addressed to the alert message unit.

An exemplary method of distributing messages is also provided. Information regarding an alert is received. The received information is embedded into a cable television signal to create a modified cable television signal. The modified cable television signal is sent to an alert message unit. An auto-dialer is activated through the alert message unit such that audio information regarding the alert is conveyed to one or more telephone numbers.

Other principal features and advantages will become apparent to those skilled in the art upon review of the following drawings, the detailed description, and the appended claims.

### BRIEF DESCRIPTION OF THE DRAWINGS

FIG. 1 is a block diagram illustrating an alert messaging system in accordance with an exemplary embodiment.

FIG. 2 is a block diagram illustrating an alert message unit in accordance with an exemplary embodiment.

FIG. 3 is a front view of an alert message unit in accordance with an exemplary embodiment.

### DETAILED DESCRIPTION

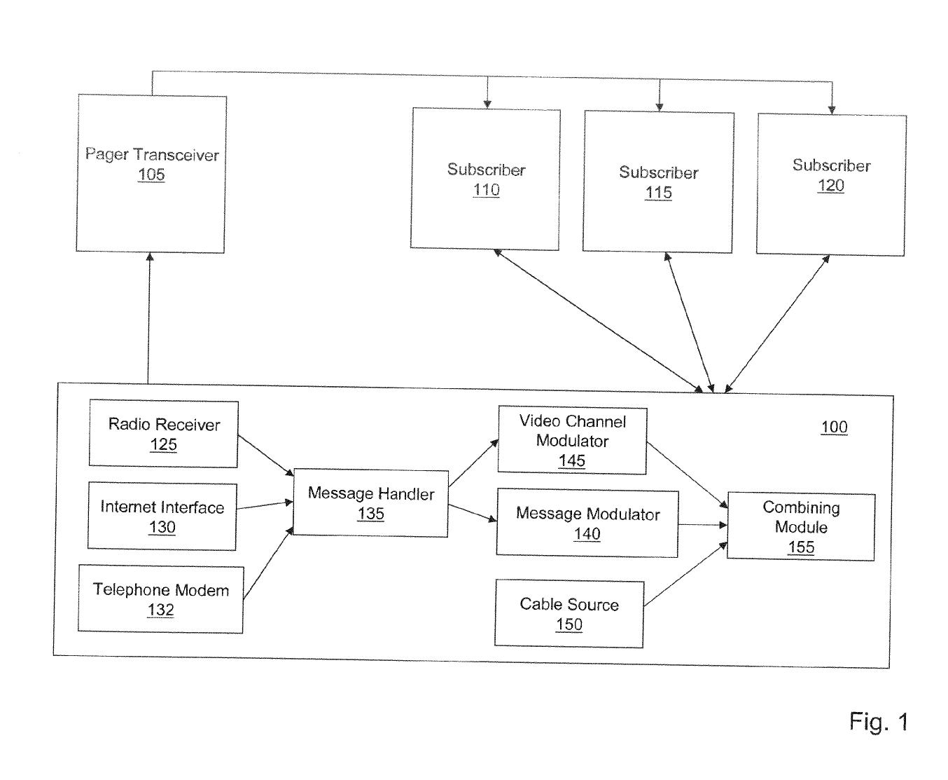

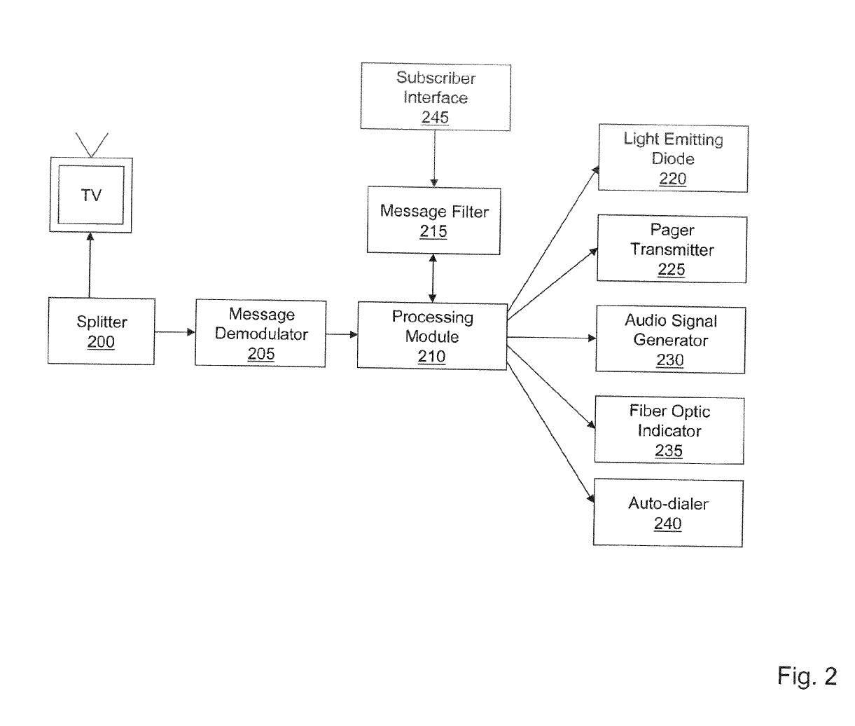

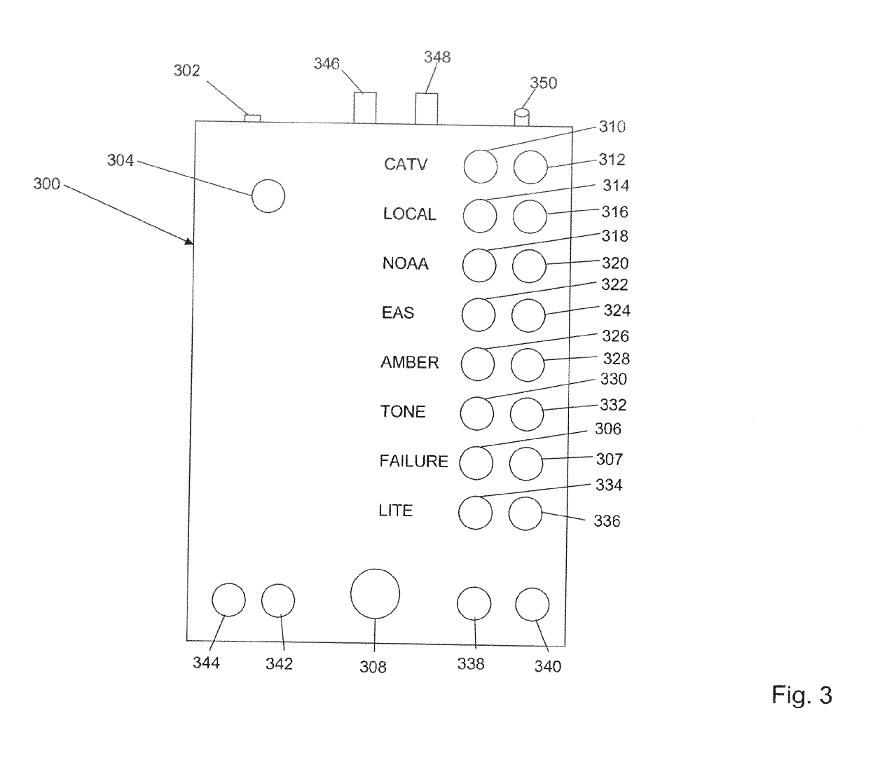

FIG. 1 is a block diagram illustrating an alert messaging system in accordance with an exemplary embodiment. In alternative embodiments, the alert messaging system may include fewer, additional, or different components. The alert messaging system includes a head end system 100, a pager transceiver 105, and subscribers 110, 115, and 120. In an exemplary embodiment, head end system 100 can communicate with subscribers 110, 115, and 120 through a wired cable connection. Head end system 100 can communicate with pager transceiver 105 through a wired or wireless connection, depending on the embodiment. Pager transceiver 105 can communicate with subscribers 110, 115, and 120 through a wireless connection. Subscribers 110, 115, and 120 can each have an alert message unit through which communication with head end system 100 is conducted. The alert message unit is described in more detail with reference to FIGS. 2 and 3. Subscribers 110, 115, and 120 can also have one or more pager units configured to receive transmissions from pager transceiver 105.

Head end system 100 can receive messages through a radio receiver 125, an Internet interface 130, and a telephone modem 132. For example, weather related messages may be transmitted from the National Oceanic & Atmospheric Administration (NOAA) on a frequency modulation (FM) radio channel and received at head end system 100 through radio receiver 125. Similarly, local law enforcement messages may be transmitted through a networked computer and received at head end system 100 through Internet interface 130. Alternatively, head end system 100 can receive messages from any other source and/or through any other communication medium. Exemplary messages can include emergency alert system (EAS) messages, police messages, public utility messages, school-related messages, National Oceanic & Atmospheric Administration (NOAA) messages, America's Missing Broadcast Emergency Response (AMBER) messages, Child Alert Foundation (CAF) messages, product marketing messages, sports messages, road construction messages, natural disaster messages, etc.

Messages received through radio receiver 125, Internet interface 130, and telephone modem 132 can pass through a message handler 135. Message handler 135 can be a computer system which formats received messages for transmission to subscriber(s). In one embodiment, message handler 135 can identify recipients of a received message based on the source of the received message, the type of received message, an address associated with the received message, and/or subscriber data. Received messages can be categorized as broadcast messages, group messages, or individual messages. A broadcast message can be sent to all subscribers in communication with head end system 100, a group message can be sent to members of a group, and an individual message can be sent to a specific subscriber. An exemplary broadcast message may be a severe weather warning which affects all of the subscribers in a given geographical area. An exemplary group message may be a fire alert message which is sent to a group of volunteer firefighters. Groups can also include teams, societies, associations, business owners, etc. An exemplary individual message may be a police alert notifying an individual that he/she is in immediate danger.

In an exemplary embodiment, received messages can be sent to the proper subscriber(s) based on a unique address associated with the alert message unit possessed by the subscriber. For example, subscriber 110 can have a first alert message unit with a first address, subscriber 115 can have a second alert message unit with a second address, and subscriber 120 can have a third alert message unit with a third address. Message handler 135 can access a database of subscriber alert message unit addresses to ensure that received messages are directed to the correct subscribers. In one embodiment, head end system 100 can send received messages to all subscribers, and alert message units of the subscribers can determine, based on addressees) associated with the message, whether the message is intended for a given subscriber. Alternatively, head end system 100 can send received messages only to the message alert units which are supposed to receive them. In one embodiment, message handler 135 can also validate the authenticity and validity of received messages to ensure that irrelevant and/or inappropriate messages are not inadvertently sent to subscribers.

In an exemplary embodiment, message handler 135 can generate or format an alert message based on a received message. The alert message can include address(es) to which the received message is directed and a message type corresponding to the received message. In an exemplary embodiment, the alert message can be used to activate the alert message unit. The alert message can be sent through a message modulator 140. Message modulator 140 can be used to encode and modulate the alert message to an available frequency. In an exemplary embodiment, frequency shift keying (FSK) modulation can be used by message modulator 140. Alternatively, any other type of modulation may be used. In one embodiment, a guard band frequency can be used to transmit the alert message to the alert message unit. Alternatively, any frequency supported by the cable television system can be used.

Message handler 135 can also generate or configure a video message to be conveyed through a television. The video message can include video, audio, text, and/or graphics based on the received message. The video message can be encoded using a standard such as National Television System Committee (NTSC) standard, a phase alternation line (PAL) standard, etc., and can be sent from message handler 135 to a video channel modulator 145. Video channel modulator 145 can be used to modulate the video message to an available channel within the cable television system such that the message can be viewed, heard, or otherwise experienced through the available channel. The alert message from message modulator 140, the video message from video channel modulator 145, and a cable source 150 can be combined by a combining module 155 such that a single cable television signal is formed. The alert message, video message, and cable source signal can be combined by any method known to those of skill in the art. In an alternative embodiment, video channel modulator 145 and message modulator 140 may be combined into a single unit.

In an exemplary embodiment, head end system 100 can provide the cable television signal to all of subscribers 110, 115, and 120. Any alert messages incorporated into the cable television signal can include one or more addresses corresponding to alert message units which are supposed to receive the messages. An alert message unit with an address not included in the alert message can ignore the message. For example, an alert message incorporated into the cable television signal may be addressed to an alert message unit possessed by subscriber 110. The alert message unit of subscriber 110 can receive the alert message and notify subscriber 110 of the alert message through an alert mechanism. Subscriber 110 can tune his/her television to a predetermined channel to experience the video message corresponding to the alert message. The alert message units possessed by subscribers 115 and 120 can determine that the alert message is not directed to subscribers 115 and 120, and can ignore the alert message. As such, subscribers 115 and 120 are not alerted by their respective alert message units. In an alternative embodiment, the alert message may only be sent to subscribers who are to receive the message.

Head end system 100 can also provide an indication of a received message to pager transceiver 105. The indication of the received message can include address information identifying pagers to which the message is to be sent, a message type of the message, and/or a textual version of the message. In an exemplary embodiment, subscribers 110, 115, and 120 can each have a pager unit which is configured to receive pages from pager transceiver 105. Using a pager address or other pager identification associated with the message, pager transceiver 105 can determine to which pager units the message is to be sent. Pager transceiver 105 can send the received message to the appropriate pager unit(s) through any wireless communication model known to those of skill in the art.

As an example, a message for subscriber 110 can be received through Internet interface 130 of head end system 100. Head end system 100 can incorporate an alert message and a video message corresponding to the received message into a cable television signal, and send the cable television signal to the alert message unit possessed by subscriber 110. As such, the alert message unit can activate an alert mechanism based on the alert message, and the video message can be conveyed through a television of subscriber 110. Head end system 100 can also provide an indication of the received message to pager transceiver 105. Pager transceiver 105 can wirelessly convey a textual representation of the received message to one or more pager units associated with subscriber 110. Pager transceiver 105 can be in wired or wireless communication with head end system 100, depending on the embodiment. In an exemplary embodiment, pager transceiver 105 can operate within an open frequency band, such as the multi-use radio system (MURS) band, so that a license is not needed.

In an exemplary embodiment, subscribers 110, 115, and 120 can also communicate information back to head end system 100. Information transmitted from subscribers 110, 115, and 120 can include a notification of a cable service outage, a notification of a power outage, a reply to a status check request, an acknowledgement that a message or other information was received, or any other information regarding the cable television service. The information can be transmitted through the alert message units possessed by subscribers 110, 115, and 120, and can be sent as a reverse signal through a cable television line. Alternatively, an auto-dialer in communication with the alert message unit can be used to provide information to head end system 100.

FIG. 2 is a block diagram illustrating an alert message unit in accordance with an exemplary embodiment. In alternative embodiments, the alert message unit may include fewer, additional, or different components. The alert message unit includes a splitter 200. Splitter 200 receives a cable television signal from head end system 100 described with reference to FIG. 1. Splitter 200 allows the television portion of the cable television signal (i.e., cable television programming and any video messages) to pass through the alert message unit to a television. The television portion of the signal can pass directly to the television, or through a set-top box in communication with the television, depending on the embodiment. Splitter 200 can also direct any alert messages in the cable television signal to a message demodulator 205.

Message demodulator 205 can be used to demodulate an alert message portion of the cable television signal. Demodulator 205 can demodulate the alert message according to any method known to those of skill in the art. The demodulated alert message can be received by a processing module 210. Processing module 210 can be a microprocessor, an application specific integrated circuit (ASIC), or any other logical component capable of processing the alert message and controlling the alert message unit. Processing module 210 can compare an address associated with the demodulated alert message to a unique address associated with the alert message unit. If the addresses do not match (i.e., the alert message is not directed to the alert message unit), processing module 210 can disregard the alert message. If the addresses match, processing module 210 can determine that the alert message is intended for the alert message unit.

If processing module 210 determines that the alert message is addressed to the alert message unit, processing module 210 can identify a type of the alert message. The type can be a CAF alert, an NOAA alert, an AMBER alert, an EAS alert, an express marketing alert, etc. Processing module 210 can determine whether to activate an alert mechanism based on whether the subscriber has disabled or enabled receipt of the particular alert message. A subscriber can program a message filter 215 to identify types of messages which are to be ignored and/or types of messages which are to be conveyed through the alert message unit. Processing module 210 can access message filter 215 to determine whether to activate one or more alert mechanisms in response to the alert message. Message filter 215 settings can be saved in a non-volatile memory of the alert message unit.

If processing module 210 determines that the alert message has not been filtered by the subscriber, processing module 210 can activate one or more alert mechanisms. Alert mechanisms can include a light emitting diode 220, a pager transmitter 225, an audio signal generator 230, a fiber optic indicator 235, and an auto-dialer 240. The activated alert mechanism(s) can be used to notify the subscriber of the alert message regardless of the location of the subscriber and regardless of whether the subscriber's television is turned on. In an exemplary embodiment, each type of message can have a corresponding light emitting diode (LED) 220. For example) processing module 210 may cause a first LED to illuminate in response to an AMBER alert message, and a second LED to illuminate in response to a NOAA alert message. The subscriber can see that light emitting diode 220 is illuminated and be informed that an alert message has issued. The subscriber can ignore the alert message, activate a control to turn off light emitting diode 220, and/or turn on the television to find out more information regarding the alert message. Alternatively, light bulbs or any other type of visual indicator(s) can be used.

Pager transmitter 225 can be used to notify pager transceiver 105 described with reference to FIG. 1 that a message is to be sent to one or more pager units in possession of the subscriber. The message sent to the one or more pager units can be an indication that an alert message has issued. Alternatively, the message sent from pager transceiver 105 to the one or more pager units can be a textual message providing details regarding the issued alert message. Such a textual message can be generated by the alert message unit or head end system 100 described with reference to FIG. 1, depending on the embodiment. For example, a husband who is working in the front yard may have a first pager unit and a wife who is working in the back yard may have a second pager unit. Pager transmitter 225 can send a signal to pager transceiver 105 that an alert message addressed to the husband and wife has issued. Pager transceiver 105, which can be mounted on a telephone pole or other accessible location, can receive the signal from the alert message unit and send a page regarding the alert message to the first pager unit and the second pager unit. In an alternative embodiment, the alert message unit may not include pager transmitter 225 such that pager transceiver 105 communicates only with head end system 100 and the pager units.

Audio signal generator 230 can be used to notify subscribers within hearing range of the alert message unit of an alert message. The audio signal generated by audio signal generator 230 can be intermittent or constant, and can be any type of sound, including a beep, a buzz, a jingle, one or more words, etc. Audio signal generator 230 can be any type of audio generator known to those of skill in the art. As an example, processing module 210 can determine that a received message is to be conveyed through the alert message unit. Processing module 210 can activate audio signal generator 230 such that a sound is emitted from the alert message unit. The sound can notify a subscriber located in the next room or otherwise close to the television that an alert message has issued. In an exemplary embodiment, audio signal generator 230 can be deactivated by the subscriber. In one embodiment, audio signal generator 230 can include a speaker such that a voice alert is emitted. For example, in response to an AMBER alert, audio signal generator 230 may emit the words “AMBER alert” such that a vision impaired user is not forced to rely on light emitting diode 220. In an exemplary embodiment, the voice alert can be the same voice alert provided through auto-dialer 240.

Fiber optic indicator 235 can be used to provide a visual signal to the subscriber through a fiber optic cable. The fiber optic cable can extend several feet from the alert message unit and can be used to alert the subscriber when the alert message unit is obstructed or otherwise hidden from view. As an example, the alert message unit may be mounted behind a television set such that a subscriber sitting on his/her couch is unable to see the alert message unit. Fiber optic indicator 235 can be positioned such that it is visible to the subscriber. In response to an appropriate alert message, processing module 210 can cause light to emit through fiber optic indicator 235 and any fiber optic cable such that the subscriber is notified of the alert message. In an exemplary embodiment, fiber optic indicator 235 can be deactivated by the subscriber and independently controlled/programmed for the different types of alerts supported by the alert message unit.

Auto-dialer 240 can be used to call telephone numbers in response to an appropriate alert message. Auto-dialer 240 can be incorporated within the alert message unit as a daughterboard, or located external thereto, depending on the embodiment. If auto-dialer 240 is located external to the alert message unit, auto-dialer 240 and alert message unit can communicate through any wired or wireless communication method known to those of skill in the art. In an exemplary embodiment, the subscriber can program auto-dialer 240 to dial one or more telephone numbers in response to an issued alert message. The subscriber can program the auto-dialer such that a telephone call is made in response to a first alert message regarding school closures, but not in response to a second alert message regarding weather alerts. A voice message regarding the alert message can be conveyed through auto-dialer 240. The voice message may indicate the type of the alert message and/or may provide details regarding the alert message. The voice message can be generated by processing module 210 or by head end system 100, depending on the embodiment. As an example, a NOAA alert message can be received and processed at the alert message unit. Auto-dialer 240 can be used to convey an audio message regarding the NOAA alert message to a cell phone of a husband, a cell phone of a wife, and a work telephone of the wife.

In an exemplary embodiment, auto-dialer 240 can also be used to inform head end system 100 described with reference to FIG. 1 of problems regarding the subscriber's cable signal. For example, the alert message unit can determine that the cable signal being received by the subscriber is missing or faulty. Auto-dialer 240 can be used to notify head end system 100 that there is a problem. Operators of head-end system 100 can determine the problem with the signal, and ensure that a corrected signal is provided to the subscriber as soon as possible. As such, cable outages can be fixed before the subscriber even knows that his/her cable is out. In one embodiment, auto-dialer 240 can be configured to call a plurality of different telephones through a plurality of telephone lines. Alternatively, auto-dialer 240 may be configured to call head end system 100 over a single telephone line in response to an alert. In such an embodiment, head end system 100 can call one or more telephones and deliver a voice alert corresponding to the alert.

The alert message unit also includes a subscriber interface 245. Subscriber interface 245 can be used by the subscriber to program message filter 215. For example, a subscriber can decide that he/she does not wish to receive alerts regarding missing children, and can cause AMBER alert messages and CAF alert messages to be filtered by message filter 215. Subscriber interface 245 can also be used to manually deactivate one or more of the alert mechanisms. For example, a control on subscriber interface 245 can be used to turn off light emitting diode 220 or to stop audio signal generator 230. Subscriber interface 245 can also be used to program pager transmitter 225 and/or auto-dialer 240. Subscriber interface 245 is described in more detail with reference to FIG. 3.

FIG. 3 is an alert message unit 300 in accordance with an exemplary embodiment. Alert message unit 300 includes a power input 302 such that the unit can receive electrical power from an AC electrical source. Alert message unit 300 can also include a power storage device such that alert message unit 300 is able to operate during a power outage. In an exemplary embodiment, the power storage device can be a super capacitor. The super capacitor can remain charged during normal operation of the alert message unit 300, and provide backup power during a power outage. Alternatively, the power storage device can be a battery or any other device capable of storing electrical power as known to those of skill in the alt. In one embodiment, alert message unit 300 can be configured to enter a low power mode during a power outage. In the low power mode, one or more of the alert mechanisms of alert message unit 300 can be disabled. For example, light emitting diode 220, pager transmitter 225, fiber optic indicator 235, and/or auto-dialer 240 may be deactivated during the low power mode, and audio signal generator 230 may be used to notify a user of an alert. Alternatively, any other combination of alert mechanisms may be used during the low power mode. The low power mode can be implemented through power detecting circuitry as known to those of skill in the art.

Alert message unit 300 includes a heartbeat indicator 304 which can be used to indicate system status. In an exemplary embodiment, heartbeat indicator 304 can pulse at a given rate when a valid cable television signal is being received. If the cable television signal is interrupted, lost, or degraded, heartbeat indicator 304 can pulse at a lower rate until heartbeat indicator 304 goes out. Alternatively, heartbeat indicator 304 can immediately stop pulsing and go out or remain lit upon detection of an invalid cable television signal. If there is a qualified loss of the forward channel data stream or if AC power is removed, a FAILURE LED 306 can be illuminated to notify the subscriber. A FAILURE button 307 can be used to turn off FAILURE LED 306. In the event of a power loss, alert message unit 300 can revert to battery power. In addition, if a problem is detected with the cable television signal and/or the power supply, auto-dialer 240 described with reference to FIG. 2 can be used to call the cable provider and inform it of the outage. The unique address corresponding to alert message unit 300 can be encoded in dual-tone multi-frequency (DTMF) tones such that the cable provider knows exactly which subscriber is having problems.

Alert message unit 300 also includes a program button 308. Program button 308 can be used by a subscriber to disable any of the alerts with the exception of the EAS alert. Program button 308 can also be used by the subscriber to determine, for each alert, whether the activated alert mechanism is visual only, audio only, or both visual and audio. In one embodiment, program button 308 can also be used to program telephone numbers for the auto-dialer function of the alert message unit 300.

Alert message unit 300 includes a cable television (CATV) LED 310 such that a subscriber can be informed of a CATV alert. A CATV alert can allow the cable television provider to notify subscribers of cable outages, the need to disable cable service, etc. A CATV button 312 can be used by the subscriber to turn off CATV LED 310. In an exemplary embodiment, in response to a CATV alert, CATV LED 310 will remain on for a predetermined amount of time if the subscriber does not turn CATV LED 310 off. Alternatively, CATV LED 310 can remain on until the issue causing the CATV alert is resolved. CATV button 312 can also be used in conjunction with program button 308 to control whether CATV alerts are conveyed through alert message unit 300.

Alert message unit 300 includes a LOCAL LED 314 such that a subscriber can be informed of local alerts concerning school delays, school closings, police alerts, and other local issues. A LOCAL button 316 can be used by the subscriber to turn off LOCAL LED 314. LOCAL button 316 can also be used in conjunction with program button 308 to control whether local alerts are conveyed through alert message unit 300. A National Oceanic & Atmospheric Administration (NOAA) LED 318 can be used to inform the subscriber of an NOAA alert, and a NOAA button 320 can be used by the subscriber to turn off NOAA LED 318. An emergency alert system (EAS) LED 322 can be used to inform the subscriber of an EAS alert, and an EAS button 324 can be used to turn off EAS LED 322. An America's Missing Broadcast Emergency Response (AMBER) LED 326 can be used to inform the subscriber of an AMBER alert, and an AMBER button 328 can be used to turn off AMBER LED 326. A child alert foundation (CAF) LED 338 can be used to inform subscribers of a CAF alert, and a CAF button 340 can be used to turn off CAF LED 338. NOAA button 320, AMBER button 328, and CAF button 340 can all be used in conjunction with program button 308 to control whether and how the corresponding alerts are conveyed through alert message unit 300.

Alert message unit 300 also includes a TONE LED 330 which can light up if an audio warning for a given alert is activated. For example, the audio warning can be activated for NOAA alert messages. During an NOAA alert, TONE LED 330 can light up to indicate that the audio warning is active. A TONE button 332 can be used to turn off the audio warning and/or to program the audio warning. In an exemplary embodiment, operation of the audio warning can be independently set for each type of alert message. A LITE LED 334 can be used to indicate that a fiber optic connection 350 is activated. A LITE button 336 can be used to turn LITE LED 334 and fiber optic connection 350 on and off. In an exemplary embodiment, fiber optic connection 350 is configured to receive a fiber optic cable such that a visual indication of an alert message can be provided several feet from alert message unit 300.

Alert message unit 300 includes an input 346 and an output 348. Input 346 can receive a cable television signal, including alert messages and video messages, from the cable television provider. Input 346 can receive the cable television signal through a coaxial cable, or through any other signal conveying medium known to those of skill in the art. Output 348 can be in communication with the television or a set-top box connected to the television. Output 348 can be connected to the television through a coaxial cable, or through any other signal conveying medium known to those of skill in the art.

Alert message unit 300 also includes an express marketing LED 342 and an express marketing button 344 which can be used to turn off express marketing LED 342. Express marketing button 344 can also be used in conjunction with program button 308 to control whether and how express marketing alert messages are conveyed through alert message unit 300. Express marketing LED 342 can be used to provide subscribers with sales notifications from local merchants. For example, if a supermarket has excess produce which is to be sold at a discount on a given day or during a given time period, the supermarket can notify the cable provider and have the cable provider issue an express marketing alert. Express marketing LED 342 can light up, and the subscriber can be notified of the produce sale by tuning his/her television to a predetermined channel.

The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An alert message unit for use in a message distribution system, the alert message unit comprising:
an input configured to receive a cable television signal;
a processing module in communication with the input, wherein the processing module is configured to
locate an alert message, wherein the alert message is embedded within a frequency band of the cable television signal;
determine whether the located alert message is addressed to the alert message unit; and
activate an alert mechanism if the alert message is addressed to the alert message unit; and
the alert mechanism.

2. The alert message unit of claim 1, wherein the alert mechanism comprises an auto-dialer capable of delivering an audio indication of the located alert message to one or more telephone numbers.

3. The alert message unit of claim 1, wherein the alert mechanism comprises a visible light which is emitted from the alert message unit.

4. The alert message unit of claim 3, wherein the visible light is emitted from a light emitting diode.

5. The alert message unit of claim 3, wherein the visible light is emitted through a fiber optic cable.

6. The alert message unit of claim 1, wherein the alert mechanism comprises an audible signal generator configured to emit an audio alert from the alert message unit.

7. The alert message unit of claim 1, further comprising a power storage device such that the alert message unit is operable in the event of an electrical power loss.

8. The alert message unit of claim 1, wherein the located alert message comprises at least one of a missing child message, a school closing message, a weather message, a national security message, a product sales message, a law enforcement message, a public works message, an emergency alert system message, and a non-profit organization message.

9. The alert message unit of claim 1, further comprising an output in communication with a television, wherein the output is configured to convey a video message corresponding to the located alert message to the television.

10. The alert message unit of claim 1, wherein the located alert message comprises a group message which is addressed to a predetermined plurality of alert message units.

11. A system for distributing messages, the system comprising:
a head end system, wherein the head end system is configured to
embed an alert message within a cable television signal to create a modified cable television signal; and
send the modified cable television signal to an alert message unit; and
the alert message unit in communication with the head end system, wherein the alert message unit comprises
an input configured to receive the modified cable television signal; and
a processing module in communication with the input, wherein the processing module is configured to
locate the alert message within the modified cable television signal;
determine whether the located alert message is addressed to the alert message unit; and
activate an alert mechanism if the located alert message is addressed to the alert message unit.

12. The system of claim 11, wherein the head end system is further configured to create the alert message based on a received message.

13. The system of claim 11, wherein the head end system is further configured to embed a video message corresponding to the alert message within the cable television signal to create the modified cable television signal.

14. The system of claim 11, wherein the alert mechanism comprises an auto-dialer.

15. The system of claim 11, further comprising a pager transceiver configured to
receive an indication of the alert message from the head end system; and
send the indication of the alert message to a pager unit associated with the alert message unit.

16. A method of distributing messages, the method comprising:
receiving information regarding an alert;
embedding the received information into a cable television signal to create a modified cable television signal; and
sending the modified cable television signal to an alert message unit; and
activating an auto-dialer through the alert message unit such that audio information regarding the alert is conveyed to one or more telephone numbers.

17. The method of claim 16, further comprising sending an indication of the information to a pager transceiver.

18. The method of claim 17, further comprising sending the indication of the information from the pager transceiver to a pager unit associated with the alert message unit.

19. The method of claim 16, further comprising determining whether the information is addressed to a unique address of the alert message unit.

20. The method of claim 17, wherein the alert comprises at least one of a missing child notice, a school closing, a weather report, a national security issue, a product sale, a law enforcement issue, a public works issue, an emergency alert system issue, and a non-profit organization issue.
